(19) United States
(12) Patent Application Publication
(10) Pub. No.: US 2009/0287547 A1
(43) Pub. Date: Nov. 19, 2009

(54) SALES BENCHMARKING AND COACHING TOOL

(76) Inventor: Robert T. Scanlon, South Russell, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/465,175

(22) Filed: May 13, 2009

Related U.S. Application Data
(60) Provisional application No. 61/052,929, filed on May 13, 2008.

(51) Int. Cl. G06Q 99/00; G06Q 10/00; G06Q 50/00

(52) U.S. Cl. 705/10; 705/1

(57) ABSTRACT

A machine- or computer-implemented sales coaching tool and methodology provide a method for a user to evaluate a sales or marketing opportunity of interest. The sales coaching tool, method, and system are configured to present users with one or more questions related to one or more marketing conditions, receive a user response to the questions, process the received responses, and provide an advice package based on the responses. The advice package may include coaching advice and/or a benchmark of where the user may have strengths or vulnerabilities with respect to an opportunity of interest.

### CROSS REFERENCE TO RELATED APPLICATIONS

The present application claims the benefit of U.S. Provisional Application Ser. No. 61/052,929, filed May 13, 2008, and which is incorporated by reference in its entirety.

### TECHNICAL FIELD

The present invention relates generally to machine-implemented tools, and more particularly, to a computer-implemented sales coaching tool and methodology.

### BACKGROUND

Companies in virtually every industry employ salespeople to sell goods and services. Whether in auto sales, industrial sales or service sales, salespeople are in search of ways to improve their performance and effectiveness in selling goods and/or services.

### SUMMARY OF THE INVENTION

Aspects of the disclosed technology relate to a computer-implemented sales coaching tool that includes a five-dimensional sales model that is effective across a variety of different sales disciplines.

One aspect of the disclosed technology relates to a machine-implemented sales coaching method that includes presenting a user with one or more status questions related to one or more sales or marketing conditions; receiving user response to the one or more status questions; processing the received user responses; and displaying a sales coaching advice package based on the received user responses.

According to another aspect, presenting includes presenting status questions according to a five-dimensional sales model.

Another aspect of the disclosed technology relates to a sales coaching tool embodied on a machine-readable medium, where the sales coaching tool includes code that presents a user with a plurality of status questions related to sales or marketing conditions; code that processes user responses to the plurality of status questions; and code that displays a sales coaching advice package based on the responses to the plurality of status questions.

Another aspect of the disclosed technology relates to a program stored on a computer-readable medium, wherein when the program is loaded and executed, the program causes the computer to present a user with one or more status questions related to one or more sales or marketing conditions; receive user input responsive to the one or more status questions; and display an advice package based on the received user input, the advice package including (i) benchmark output, and/or (ii) sales coaching output.

Another aspect of the disclosed technology relates to a sales or marketing analyzer system comprising a user input device; and a controller, the controller comprising programming and logic to present a user with one or more status questions related to one or more sales or marketing conditions; receive user response to the one or more status questions; process the received user responses; and output a sales coaching advice package based on the received user responses.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a functional block diagram of a web-based infrastructure on which aspects of the invention may be carried out;

FIG. 2 is a functional block diagram of a computer or server as an exemplary machine on which aspects of the invention may be carried out;

FIG. 3 is a flow chart illustrating a sales coaching method according to one aspect of the disclosed technology;

FIG. 4 is a flow chart illustrating a sales coaching method in accordance with aspects of the disclosed technology;

FIG. 5 is a flow chart illustrating a sales coaching method in accordance with one embodiment of the disclosed technology;

FIG. 6 illustrates an example of a display output depicting a benchmark output for a user determined via a sales coaching method in accordance with aspects of the disclosed technology; and

FIG. 7 illustrates an example of a display output depicting a sales coaching advice output determined for a user via a sales coaching method in accordance with aspects of the disclosed technology.

### DESCRIPTION OF EMBODIMENTS

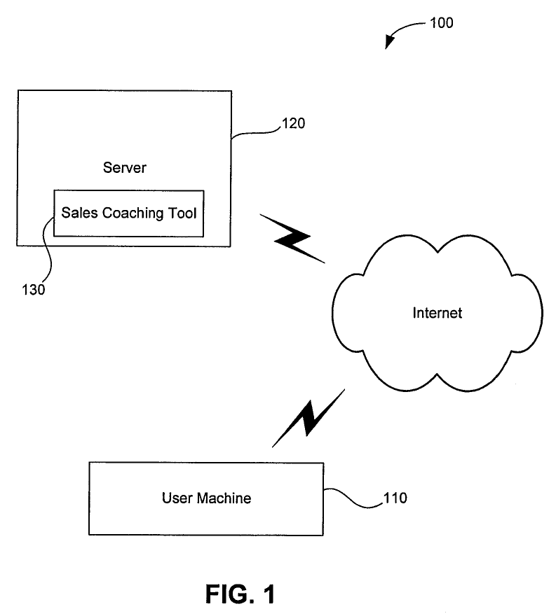

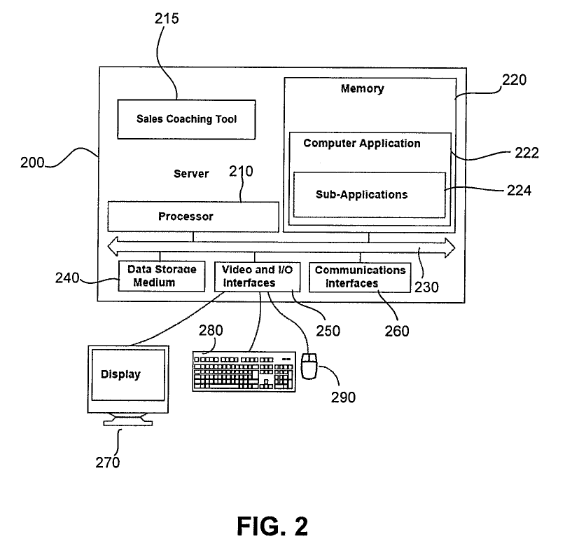

Aspects of the disclosed technology relate to a computer-implemented sales coaching and benchmarking tool (which may be referred to herein as a “sales coaching tool”) suitable for providing a user with information related to the quality of a sales or marketing opportunity of interest to a user. The information may be in the form of an advice package that may provide a user with a benchmark and/or coaching advice useful to the user to pursue and/or execute on a sales or marketing opportunity. The sales coaching tool may be effective across a variety of different sales disciplines. In one aspect, the sales coaching tool includes a five-dimensional sales model. It will be appreciated that the sales coaching tool may be implemented as a software program resident on a computing device, such as a personal computer (see, for example, FIG. 2). Alternatively, the sales coaching tool may be implemented as a web-accessible tool that may be accessed by a user via the Internet (see, for example, FIG. 1).

The present invention is described herein in terms of several exemplary embodiments that should be taken to be illustrative of the invention and not limiting thereof. For example, the invention is described in terms of a sales coaching tool in which a user may be presented with a plurality of status questions related to sales and marketing conditions. Responses to the status questions may be received and processed, and a coaching advice package may be displayed or otherwise provided.

In one aspect, the sales coaching tool makes use of a five-dimensional sales model in providing a sales coaching advice package. It will be appreciated that the provision of the five-dimensional sales model described below allows for a sales coaching tool that may be employed generally for a variety of industries without requiring industry-specific or specialized training.

Referring to FIG. 1, the sales coaching tool is illustrated in a general network or Internet environment 100 in which a user (using, for example, a machine 110) accesses the sales coaching tool 130 via the Internet, where the sales coaching tool 130 is resident on a remote network server 120.

Alternatively, the sales coaching tool may be resident on a local computer or server. FIG. 2 illustrates a schematic block diagram of the server 200. The server 200 (also known as a data storage and web page hosting device) generally includes a processor 210, a memory 220, a local interface 230, a data storage medium 240, video and input/output interfaces 250, and various communication interfaces 260. The server may include optionally a display 270, a keyboard 280, and a user input device 290 (e.g., a computer mouse, a barcode scanner, a light pen, etc.). The server may be a personal computer or other suitable server capable of supporting a web-based application. The server is generally capable of executing one or more computer application(s) 222 in accordance with aspects of the present invention. In one embodiment, the sales coaching tool 215 includes a database including questions and advice in five sales dimensions. In addition, the sales coaching tool may also include software (or computer-readable code) that permits information to be transmitted to and updated by various local and remote devices. The computer application may be logically associated with or call one or more additional computer applications 222 or one or more sub-computer applications 224, which generally include compilations of executable code.

In one embodiment, the computer application 222, and/or the sub-applications 224 are embodied as one or more computer programs (e.g., one or more software applications including compilations of executable code). The computer program(s) can be stored on a data storage medium or other computer readable medium, such as a magnetic or optical storage device (e.g., hard disk, CD-ROM, DVD-ROM, etc.).

To execute the computer application and associated database and sub-applications, the server or computer can include one or more processors 210 used to execute instructions that carry out a specified logic routine(s), for example, the sales coaching logic routine. In one embodiment, the server is based on a client-server architecture and may serve multiple clients. However, one of ordinary skill in the art will readily appreciate that any combination of computers having the functionality described herein shall be deemed to be within the scope of the present invention.

The server (120, 200) may have a memory for storing data, software, logic routine instructions, computer programs, files, operating system instructions, and the like. The memory can comprise several devices and includes, for example, volatile and non-volatile memory components. Accordingly, the memory can include, for example, random access memory (RAM), read only memory (ROM), hard disks, floppy disks, compact disks (e.g., CD ROM, DVD ROM, CD RW, etc.), tapes, and/or other memory components, plus associated drives and players for these memory types. The processor 210, memory 220, and the data storage medium 240 are coupled using a local interface 230. The local interface 230 can be, for example, a data bus with accompanying control bus, a network, or other subsystem.

The server can have various video and input/output interfaces 250 as well as one or more communications interfaces 260. The interfaces can be used to couple the server to various peripherals, such as a display (e.g., a CRT display, a LCD display, a plasma display, etc.), a keyboard, and a user input device. The communications interfaces 260 can include, for example, a modem, a network interface card, and/or a wireless network interface card. The communications interfaces 260 can enable the server to transmit and receive data signals, voice signals, video signals, and the like via an external network, such as the Internet, a wide area network (WAN), a local area network (LAN), direct data link, or similar wired (e.g., Ethernet) or wireless system (e.g., 802.11b or 802.11g). One of ordinary skill in the art will readily appreciate that a wireless communication medium and a wired communication medium may be used interchangeably to accomplish the functionality described herein and any such arrangement shall be deemed to be within the scope of the present invention.

In one embodiment, access to the sales coaching tool may be fee-based (e.g., monthly, quarterly, or yearly subscription) or non-fee based.

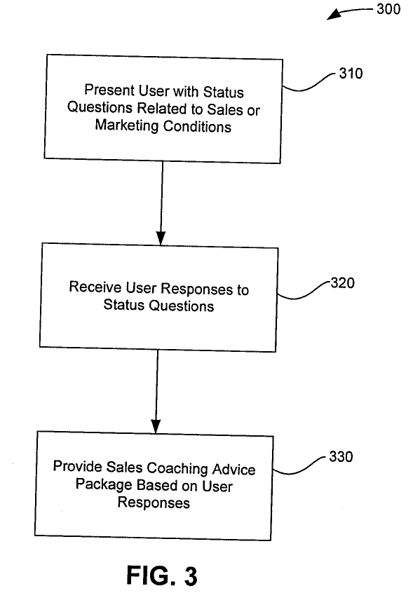

Referring to FIG. 3, a general sales coaching method in accordance with aspects of the disclosed technology is illustrated. At functional block 310, a sales coaching method 300 includes presenting a user with status questions related to sales or marketing conditions. At functional block 320, the sales coaching tool receives user responses to the status questions. At functional block 330, the sales coaching tool provides a sales coaching advice package based on the user responses. As described above and as will be further discussed herein, the advice package may include sales coaching advice and/or benchmark output. The advice may include suggestions as to areas the user may want to focus on and possible steps to pursue a sales or marketing opportunity. The benchmark output may be a representation or output that provides the user with an indication of their strengths or vulnerabilities as it relates to a sales or marketing condition (with respect to the sales or marketing opportunity of interest to the user). This benchmark may allow a user to better evaluate the quality of a sales or marketing opportunity that is of interest to them. It will be appreciated that the sales coaching tool may provide benchmark output for the user, coaching advice for the user, or both.

As described above, the method includes presenting a user with status questions related to sales or marketing conditions. The sales or marketing conditions may relate to a particular dimension of a sales or business model, and the terms “sales or marketing condition,” “sales model dimension,” and “sales dimension” may be used interchangeably herein. The sales coaching tool may be configured to evaluate one or more sales dimensions and provide a user with an assessment of a sales opportunity and/or provide a user with coaching advice with respect to one or more sales dimensions.

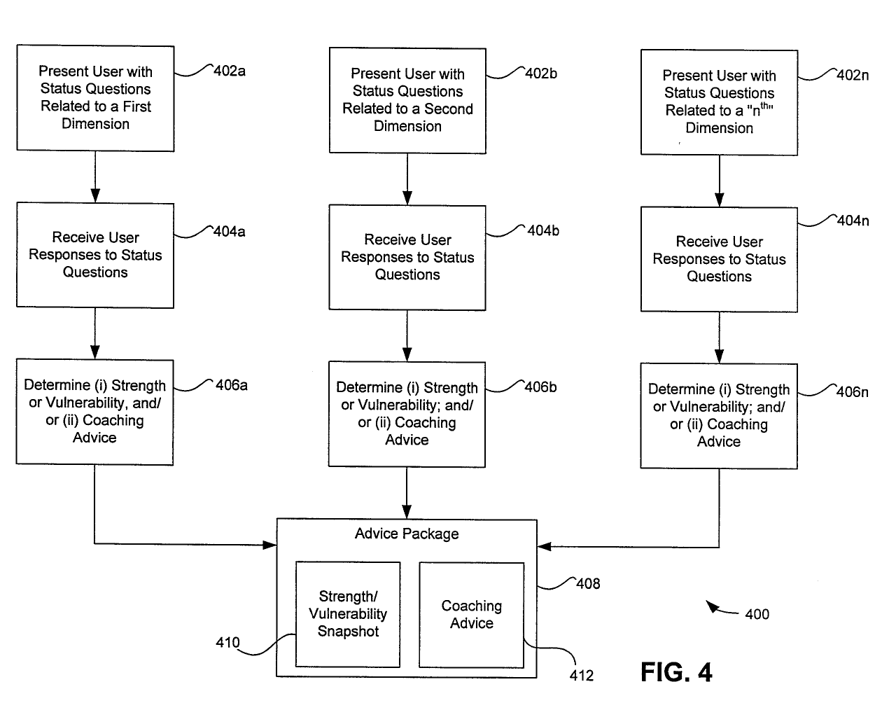

FIG. 4 is a flow chart illustrating a process 400 by which a sales coaching tool may evaluate a sales opportunity for a user with respect to multiple sales dimensions. At functional block 402a, the sales coaching tool presents a user with one or more status questions related to a first sales dimension. At functional block 404a, the coaching tool receives user responses to the questions related to the first sales dimension. The process may then proceed to functional block 406a, where the sales coaching tool uses the user's responses to determine sales coaching advice and/or benchmark data for the user with respect to the particular dimension being evaluated.

After evaluating a first sales or marketing dimension, the sales coaching tool may proceed to evaluate a second sales or marketing dimension. Referring to FIG. 4, the sales coaching tool may proceed to functional block 402b and present a user with one or more status questions related to a second sales dimension. At functional block 404b, the coaching tool receives responses to the questions related to the second sales dimension. The process may then proceed to functional block 406b where the sales coaching tool determines benchmark data and/or coaching advice based on the user's responses.

As described above, the sales coaching tool may be configured to evaluate any desired number (n) of sales dimensions. Thus, as shown in FIG. 4, the process may evaluate an “n^{th}” sales or marketing dimension of interest by presenting, at functional block 402n, a user with one or more status one or more status questions related to a second sales dimension. At functional block 404n, the coaching tool receives responses to the questions related to the second sales dimension. The process may then proceed to functional block 406n where the sales coaching tool uses the user's responses to determine sales coaching advice and/or benchmark data for the user with respect to the particular dimension being evaluated.

As discussed further herein, in an exemplary embodiment, the sales coaching tool is configured to make use of five-dimensional sales model to provide an advice package. Applicant has found that the use of a five-dimensional sales model provides a sales coaching tool suitable for providing advice to sales persons over multiple industries. As such, the use of a sales coaching tool configured to utilize a five-dimensional sales model has been found to make the tool more universal in terms of its application. Examples of suitable dimensions that may be analyzed by a sales coaching tool, including exemplary dimensions for use in a tool utilizing a five-dimensional sales model, are discussed further herein.

After the sales coaching tool has conducted the analysis with respect to each sales or marketing dimension of interest, the process may proceed to functional block 408 to produce an advice package based on the analysis conducted with respect to each sales dimension. The sales coaching tool may provide (such as by a human-readable display or other suitable output) benchmark data 410 for the user with respect to each sales or marketing dimension being analyzed and/or sales coaching advice 412 based on the user responses. The information provided to the user at functional block 408 may be considered a package in that it contains a collection of data (e.g., a benchmark analysis and/or collection of advice) related to the respective dimensions that were evaluated.

As previously described, the sales coaching tool presents a user with one or more status questions related to a particular sales or marketing dimension and receives a response from the user. The questions and manner in which the question is answered by the user may be provided in any suitable manner. The term “questions” may include items presented in true question form or they may be statements, which may be referred to herein as “calibrating statements.” It will be appreciated that even statements may be answerable or responded to with a “YES” or “NO” or with a statement indicative of a degree of agreement or disagreement by the user.

In one aspect, the sales coaching tool may be configured to provide the user with a plurality of answer choices for the user to select as a response to the question. For example, the user may be presented with several answer statements as a response to a question. The answer statements may also include answers indicative of a degree to which a user agrees or disagrees with a questions/calibrating statement presented to the user, e.g., “strongly agree,” “agree somewhat,” “neutral,” “disagree somewhat,” “strongly disagree,” and the like. In another aspect, the sales coaching tool may be configured such that the user is simply asked to respond with a “YES” or “NO” answer.

The number of questions presented to the user is not limited. The sales coaching tool may be configured such that a user is presented with a predetermined number of questions that the user is asked to answer. In another embodiment in which the user is prompted to answer “YES” or “NO” to the questions, the sales coaching tool may be configured such that questioning is terminated upon receiving a “NO” answer from a user. After questioning is completed, the process may then proceed to determine a benchmark and/or sales advice for the user.

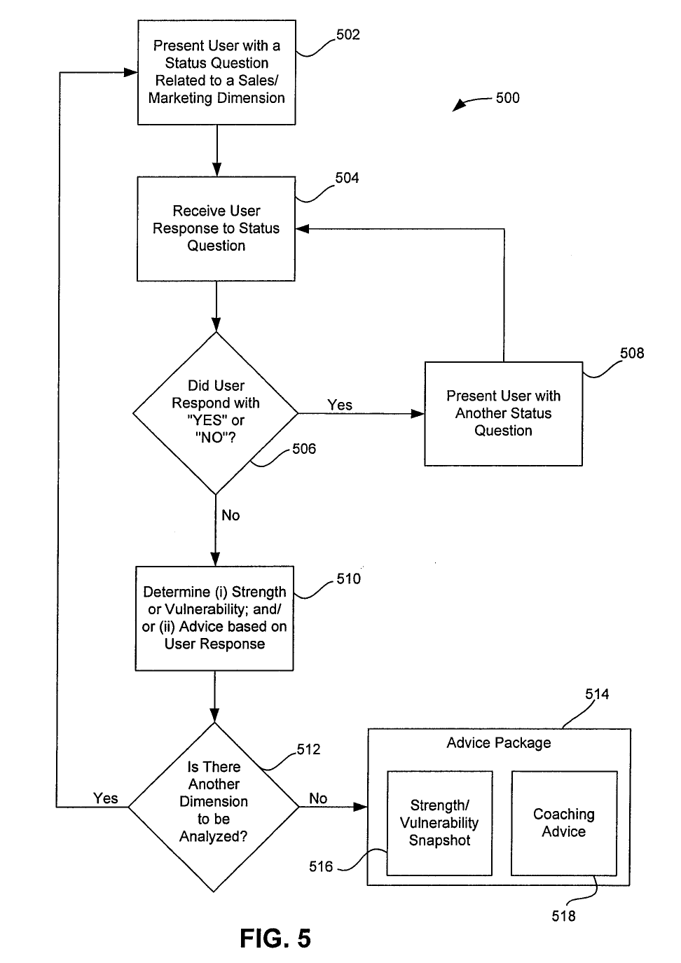

FIG. 5 illustrates a process in which the sales coaching tool is configured to receive “YES” or “NO” answers from the user and end questioning with respect to the dimension being analyzed upon receipt of a “NO” answer. In FIG. 5, the process 500 includes, at functional block 502, presenting a user with a status question related to a sales or marketing dimension. At functional block 504, the sales coaching tool receives a user response to the status question. At functional block 506, the sales coaching tool determines if the user responded with a “YES” or “NO” answer. If the user answered “YES,” the process proceeds to functional block 508, where the user is presented with an additional status question related to the dimension being analyzed. The process then proceeds to functional block 504 where the sales coaching tool receives a user response, and the sales coaching tool again determines if the user responded with a “YES” or a “NO” to the question that was presented to the user. This processing loop will be repeated as long as the user responds with a “YES” or until there are no more questions in the database or program to be asked of the user with respect to a particular dimension.

If, at functional block 506, the sales coaching tool determines that the user responded “NO” to a question, the process proceeds to functional block 510. The process will also proceed to functional block 510 if the coaching tool determines that there are no further questions to present to the user with respect to the dimension being analyzed. At functional block 510, the sales coaching tool may determine coaching advice and/or benchmark data (e.g., a degree of strength or weakness) for the user with respect to the particular dimension that was analyzed.

The process may then proceed to functional block 512, and the sales coaching tool may determine if any other sales or marketing dimensions are to be evaluated. If additional dimensions are to be analyzed, the process may flow back to functional block 502, and the sales coaching tool may present the user with status questions related to a new sales or marketing dimension. If no other dimensions are to be analyzed (e.g., only one dimension was to be analyzed or all of a plurality of dimensions of interest have been analyzed), the process proceeds to functional block 514, and the sales coaching tool will provide an advice package (such as, for example, by displaying on a display screen or other suitable output), which may include benchmark output 516 and/or coaching advice 518 determined for the user for the respective sales dimensions analyzed.

The sales dimensions analyzed by the sales coaching tool may be selected as desired for a particular purpose or intended use. In one aspect, the sales dimensions may be chosen from “prospect fit” (which may also be referred to as “fit” or “pond”), “people,” “urgency,” “winning criteria” (which may also be referred to herein as “selection criteria”), “messaging” (which may also be referred to as “banners,” “messages,” or “sticky messages”), or a combination of two or more thereof. In an exemplary embodiment, the coaching tool is configured to evaluate each of the five above-mentioned dimensions.

The type of questions being asked of the user may be selected to generally provide information about a particular dimension being analyzed. The status questions are not particularly limited and may be provided to determine desired information about the user with respect to a sales or marketing dimension of interest. Additionally, the number of questions that the sales coaching tool has stored in a database with respect to a dimension of interest is not particularly limited.

In an exemplary embodiment, the sales coaching tool is configured to present a user with a variety of status questions in five dimensions: (i) “fit” or “pond questions,” (ii) “people map questions,” (iii) “urgency questions,” (iv) “selection criteria” or “winning criteria questions,” and (v) “banner questions” or “messaging questions.”

In one embodiment, asking and answering fit or pond questions may include creation of a pond map. In presenting fit pond questions, the sales coaching tool enables users to identify an ideal customer profile, for example, based on two principles—understanding what the prospective customer needs and understanding what the user or the user's company is good at. Exemplary fit or pond questions or calibrating statements may include, for example:
We know with good certainty that the target prospect group has the right problems—problems we can solve.
The target prospect group fits fairly closely to the ideal customer profile for our solution: volume potential, size, location, etc.
The target prospect group has openly recognized that they have a problem.
We have calibrated the degree to which the target prospect group recognizes their problem and is experiencing the pain of that problem.
The target prospect group understands their problems can be solved by solutions like ours.
   Other exemplary fit or pond questions or calibrating statements are illustrated in Provisional Application Ser. No. 61/052,929, which is incorporated by reference herein in its entirety.

An exemplary pond map may include five sections such as “tipping point,” “beliefs,” “urgency driver,” “significant needs,” and “account profile.” The tipping point may indicate the most critical positive qualifiers. The beliefs may indicate the critical beliefs that make a prospect a good fit. The urgency driver may indicate the reasons a prospect would take action. The significant needs may be the most important customer needs which the solution meets. The account profile may provide an indicator of the positive demographics (e.g., size, type, location, organization, etc.).

A second dimension on which status questions may be presented includes people mapping questions, for example, looking at the organization to which the user may be selling (a specific operating unit or IT). Exemplary people map questions/calibrating statements may include, for example:
We have a way to gain entry into the targeted prospect group. We have identified the people who might serve as entry points and have arranged meetings with them.
Having gained entry into the targeted prospect group, we have developed a step-by-step plan to navigate the group person by person.
We can list on paper almost all the key players.
There is someone guiding us through the organization and process.
We have an inside coach—someone loyal to use and invested in helping us more than others.
We have an inside coach who can provide more than information, they can influence or decide the sale.
We have a specific list of everyone who will make the decision and influence the buying decision.
We have access to many of the influencers and some of the decision makers on our target list.
   Other exemplary people map questions/calibrating statements are illustrated in Provisional Application Ser. No. 61/052,929, which is incorporated herein by reference in its entirety. The people mapping questions may assist the user in identifying various people in the sales process—blockers, uncertain people, and supporters. Also, the user may be guided in gaining information about his/her targeted account group based on the coaches you have (e.g., informational coaches, influencer coaches and decision-maker coaches).

A third dimension on which status questions may be presented includes urgency questions. In one embodiment, these questions may guide the user in understanding that people will take action to the degree that they internalize and visualize the impact of the solution, e.g., getting people to establish a “go-live” date. Exemplary urgency questions/calibrating statements may include, for example:
The targeted prospect group has determined that a project in our solution area is a good idea.
There is very little that needs to be done to educate the targeted prospect group on the problem, the solution options, the market vocabulary, or the market concepts.
It is early in sales cycle. Based upon our observations and instincts this project appears to be funded.
The project has evolved past the point where the targeted prospect group makes statements like, “This is a Good idea; we will do this at the right time but not now.
The project has evolved past the point where the targeted prospect group makes statements like, “This is important.” But their actions demonstrate there is no ‘skin in the game’.
The project has evolved past the point where the project is stuck and stalled behind something else—another project.
There is a ‘Go Live Date’. (Date when the solution needs to start working.)
   Other exemplary urgency questions/calibrating statements are illustrated in Provisional Application Ser. No. 61/052,929, which is incorporated herein by reference in its entirety.

A fourth dimension on which status questions may be presented includes winning criteria (winning selection criteria). This dimension helps a user overcome a problem related to the fact that many salespeople enter a selling situation without a clear idea of what selling criteria causes them to win or causes them to lose. Knowing where you win and where you lose may be particularly useful to the salesperson. Exemplary winning or selection criteria questions/calibrating statements may include, for example:
We have a written list of our winning buying selection criteria for the solutions we will probably be proposing to the targeted prospect group.
It is early in the sales cycle, but we have an understanding of the targeted prospect group's buying selection criteria.
It is early in the sales cycle, but the targeted prospect group has a clearly articulated and perhaps even documented set of buying selection criteria.
It is early in the sales cycle, the targeted prospect group has a thorough and accurate understanding of the competitive options in the market for the solution under consideration.
We are capturing most of the attention units of the targeted prospect group as they evaluate the strengths and weaknesses of the competitive options.
It is midway through the sales cycle, we know the targeted prospect group's current buying criteria and their functional preferences.
   Other exemplary winning or selection criteria questions/calibrating statements are illustrated in Provisional Application Ser. No. 61/052,929, which is incorporated herein by reference in its entirety.

A fifth dimension of which status questions may be presented includes banner coaching (also known as messaging messages). This aspect of the sales coaching tool enables a user to imagine having a meeting with a group of prospects. After the meeting, the prospects return to their office and place a simple banner outside their office. The banner includes the user's logo with a few words or phrases summarizing the impression of the user and the user's company. That is, the banner may represent a user's message or impression that sticks with the prospective customer. Exemplary banner questions/calibrating statement may include, for example:
We have a list of banners that we can use in different selling scenarios and with different targeted prospect groups. These banners are a set of approved, digestible, company messages.
It is early in the sales cycle, but we know which banners have been embraced by the targeted prospect group.
We have developed a plan identifying the banners we want plant in this targeted prospect group.
Our banners are strong and succinctly repeated by our advocates inside the targeted prospect group.
Our positive banners are more prevalent than our competitors.
We have been able to avoid or to overcome negative banners planted by our competition.
Our banners are customer-centric and relate very well to the specific needs of the targeted prospect group. Our banners articulate the specific impact our solution will have on the targeted prospect group.
   Other exemplary banner questions/calibrating statements are illustrated in Provisional Application Ser. No. 61/052,929, which is incorporated herein by reference in its entirety.

As is discussed above and below, in one exemplary embodiment, the sales coaching tool presents a variety of questions in each of the five dimensions, and then provides an advice package output based on the responses received from the user of the sales coaching tool. The Appendix attached to Provisional Application Ser. No. 61/052,929, which is incorporated by reference herein in its entirety, provides a variety of exemplary embodiments and an exemplary database which may be used to implement the sales coaching tool.

The sales coaching tool may provide a user with an advice package comprising information related to each dimension being analyzed. In one aspect, the advice package may include a benchmark package. A benchmark package provides a user with an indication of what the risk may be with respect to a sales or marketing opportunity of interest. The benchmark may be determined in any suitable manner. For example, the answers to questions may be scored or weighted to provide a composite score for a particular dimension, and the score may be graphically represented on a display device to provide an indication of whether the user has a relatively strong position in the level of service they can provide to a potential or current customer or whether they may be more vulnerable in that dimension (with respect to an opportunity of interest to the user). As another example, where the questions are provided to be answered with a “YES” or a “NO,” the questions may be scored or presented in a sequence such that the number of questions answered by the user may represent a degree of a user's strength or vulnerability in a particular dimension.

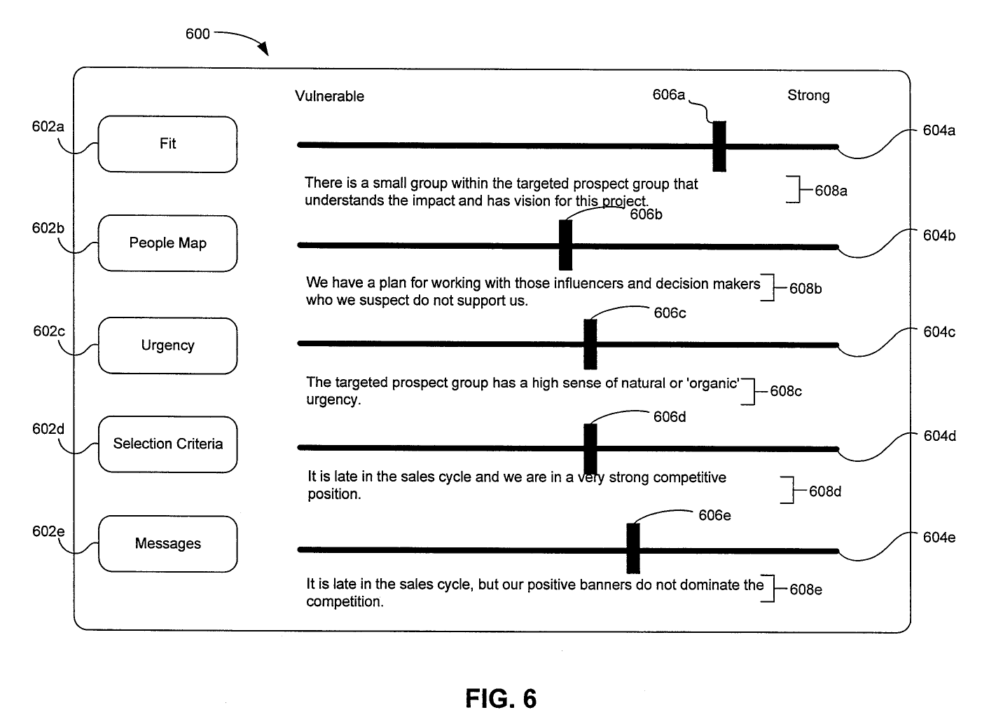

FIG. 6 illustrates an example of a possible output in the form a graphical representation suitable for display on a human-readable display for a benchmark indicating a user's strengths and vulnerabilities, based on their responses to the questions presented to them, for the respective dimensions. In the example illustrated in FIG. 6, the sales coaching tool evaluates five sales dimensions (fit, people map, urgency, selection criteria, and messages). The output (shown as a display output 600) includes an icon or image for each dimension analyzed (e.g., icons/images 602a-602e, respectively). The output further includes an axis associated with each respective dimension icon (e.g., axes 604a-604e, respectively). The output also includes an indicator bar (606a-606e, respectively) positioned on each axis. The indicator bar is positioned on the respective axes based on the user's responses to the questions presented in analyzing the respective dimensions. In FIG. 6, positioning of the indicator bar more towards the right-hand end of the axis indicates that the user is stronger in that particular dimension (with respect to the opportunity of interest for the user), and positions more toward the left indicate that the user is more vulnerable or not as strong in that particular dimension. The output may also include text (e.g., text 608a-608e) associated with each dimension. The text may provide a more particular indicator of the user's strength or vulnerability in a dimension.

As described above, benchmarking provides the user with an indicator of the risk associated with a sales or marketing opportunity of interest. The sales coaching tool provides, based on the one or more sales dimensions being evaluated, a standard of what needs to be done to have the highest odds of winning a sales or marketing opportunity. In one aspect, the standard is based on the combination of dimensions being analyzed. Upon receiving the user's answers to the questions/calibrating statements, the sales coaching tool provides the user with an indicator of what the user has done in an effort to win a sales or marketing opportunity. The gap between what has been done by the user (as determined by the answers received from the user) and the ideal standard (established based on the sales dimensions being analyzed) represents the risk associated with pursuing the sales or marketing opportunity. From the user's perspective, they may believe that the steps they have taken with respect to a sales or marketing opportunity is sufficient to put them in a strong position to win a sales or marketing opportunity. The benchmark output determined by the sales coaching tool may, however, provide them with a new perspective as to whether they have positioned themselves to have a good chance of winning a sales or marketing opportunity. The benchmark may be represented graphically (as described above, for example, with respect to FIG. 6) to provide the user with an indication of whether they are vulnerable or in positions of strength to pursue the sales or marketing opportunity. The benchmark may provide the user with an indication that a particular sales or marketing opportunity is a good fit or opportunity for the user (or the user's company). Having an assessment of the strengths or vulnerability with respect to an opportunity of interest may lower the risk on key sales or marketing opportunities.

In another aspect, the sales coaching tool provides the user with a coaching advice package based on the user's response to the status questions. The coaching advice package may be a display with one or more statements or suggestions on the type of action the user may need to take to be more effective in pursuing the sales or marketing opportunity. For example, the sales coaching tool may be programmed with certain advice that is related to or associated with a user's score for a particular dimension or associated with a particular question to which the user answered “NO”. If the user has a particular score or answers a particular question in the negative, the sales coaching tool may be configured to produce certain advice from the database. The Appendix attached to Provisional Application Ser. No. 61/052,929 (incorporated herein by reference in its entirety) provides a variety of exemplary embodiments and an exemplary database including exemplary advice, suggested strategies, and/or suggested “next steps” that may be provided as coaching advice output based on the questions answered by the user.

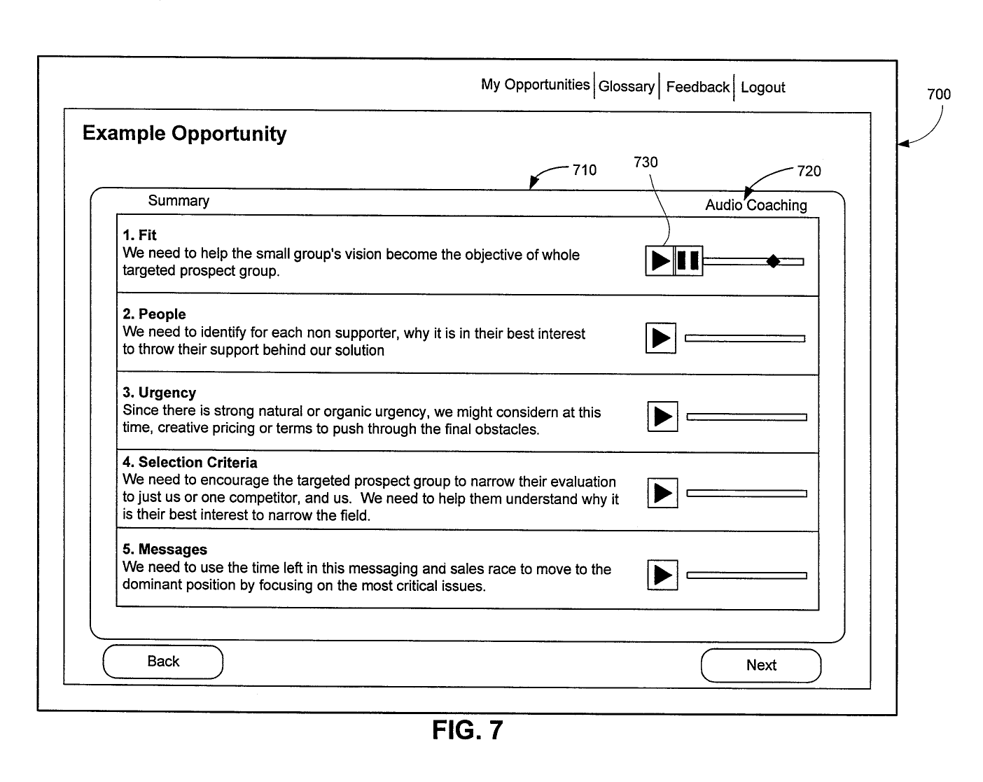

Referring to FIG. 7, an exemplary graphical representation 700 suitable for viewing on a hum display is shown providing advice output for each dimension analyzed by the sales coaching tool. The advice can be listed as text (as shown in graphical box 710). The sales coaching tool may also be configured to provide the advice as audio output. For example, as shown in FIG. 7, the display output includes a text heading 720 that reads “Audio Coaching” and icons or links 730 that, when clicked by a user, can play audio content associated with the coaching advice. The visual or textual output of the advice may be an abbreviated version of advice suitable for the user, and the audio advice output may expand on or include additional advice not included in the visual display of the advice. It will be appreciated that the amount of coaching advice provided may be selected as desired. In one aspect, such as shown in FIG. 7, a user may be presented with a short summary of the advice for the respective dimensions. The user may also be provided with an option to obtain an audio version of the advice. The audio version may be a more comprehensive presentation of the device. It will also be appreciated that more comprehensive advice may be provided to the user visually after an initial summary of the advice is provided.

In one aspect, the sales coaching tool provides a both a benchmark and coaching advice. Providing a combination of benchmark output and coaching advice is particularly suitable to provide a user with a coaching advice package to reduce a user's risk in pursuing a sales or marketing opportunity. The benchmark provides a user with information on there current status (in terms of strength or vulnerability), and the sales coaching advice provides the user with tools to deal with their current status and to move forward to try and win or execute on a sales or marketing opportunity. In one preferred aspect, the benchmark and coaching advice are determined based on a five-dimensional sales model. An exemplary five-dimensional sales model has been described above.

It will be appreciated that the sales coaching tool may be configured to store the results of an analysis. Further, the program may allow for updating a stored analysis by re-answering the questions. This may allow the user to re-evaluate an opportunity of interest and at a later date as they gain more information about a client, an industry, markets affecting a client or industry, people who may affect the project, etc. Re-evaluating a sales or marketing opportunity of interest may provide a new benchmark and/or coaching advice based on the new benchmark. By re-evaluating the analysis the user may be able to better move an opportunity along and execute on that opportunity.

Additionally, while the analysis may be general enough to be applied across multiple disciplines, it is specific enough to allow a user to evaluate several different sales or marketing opportunities. In particular, the user may be at different stages in different projects and use the sales coaching tool to effectively execute and develop those different opportunities.

The method, program, and/or system in accordance with the disclosed technology may provide a quick way for sales or marketing people to evaluate an opportunity of interest to them. The user provides answers to the questions based on their specific knowledge of an opportunity of interest to them. Answering the questions may take as little as from about 2 minutes to about 10 minutes based on the number of questions the user is required to answer during the analysis. Thus, the sales coaching tool is able to provide real-time, opportunity-specific advice and strategies to the user. This allows them to benchmark how they are executing a sales opportunity and compare their effort to best practices that minimize risk associated with pursuing and executing the opportunity.

A person having ordinary skill in the art of computer programming, and specifically in interactive software programming should consider it obvious in view of the provided description how to program a device to operate and carry out the sales coaching tool described herein. Also, while the sales coaching functionality may be carried out via a controller and/or a web access interface (alone or in conjunction with other application programs) in accordance with inventive aspects, such function also could be carried out via dedicated hardware, firmware, software, or combinations thereof without departing from the scope of the present invention.

Although the invention has been shown and described with respect to a certain exemplary embodiment or embodiments, it is obvious that equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A machine-implemented sales coaching method comprising:
presenting a user with one or more status questions related to one or more sales or marketing conditions;
receiving user response to the one or more status questions;
processing the received user responses; and
displaying a sales coaching advice package based on the received user responses.

2. The sales coaching method of claim 1, wherein the advice package includes a benchmark output indicating a degree of strength or vulnerability with respect to one or more of the sales or marketing conditions.

3. The sales coaching method of claim 1, wherein the advice package includes coaching advice.

4. The sales coaching method of claim 1, wherein presenting includes presenting one or more status questions according to a five-dimensional sales model.

5. The sales coaching method of claim 4, wherein questions in each dimension of the five-dimensional sales model are presented until a “NO” answer is received.

6. The sales coaching method of claim 4, wherein a predetermined number of questions are presented in each dimension of the five-dimensional sales model regardless of received user response.

7. The method of claim 4, wherein the five dimensions of the sales model include fit, people map, urgency, winning criteria, and banner questions.

8. The sales coaching method of claim 7, wherein questions are presented in each respective sales dimension until the user enters a “NO” answer.

9. The sales coaching method of claim 1, wherein presenting includes presenting the user with one or more pond questions; one or more people map questions; one or more urgency questions; one or more winning criteria questions; one or more banner questions or messages of a combination of two or more thereof.

10. The method of claim 9, wherein questions are presented in a category until a “NO” answer is received.

11. The method of claim 1, wherein the sales coaching advice package includes benchmark output and sales coaching advice.

12. A program stored on a computer-readable medium, wherein when the program is loaded and executed, the program causes the computer to:
present a user with one or more status questions related to one or more sales or marketing conditions;
receive user input responsive to the one or more status questions; and
display an advice package based on the received user input, the advice package including (i) benchmark output, and/or (ii) sales coaching output.

13. The program of claim 12, wherein the advice package includes benchmark output, the benchmark including a representation of a degree of strength or vulnerability with respect to the one or more sales or marketing conditions.

14. The program of claim 12, wherein the program presents one or more status questions according to a five-dimensional sales model.

15. The program of claim 14, wherein questions in each dimension of the five-dimensional sales model are presented until a “NO” answer is received.

16. The program of claim 14, wherein the five dimensions of the sales model include fit, people map, urgency, winning criteria, and banner questions.

17. The program of claim 16, wherein questions are presented in each respective sales dimension until the user enters a “NO” answer.

18. The program of claim 12, wherein the program presents the user with one or more pond questions; one or more people map questions; one or more urgency questions; one or more winning criteria questions; one or more banner questions or messages of a combination of two or more thereof.

19. The program of claim 18, wherein questions are presented in a category until a “NO” answer is received.

20. A sales or marketing analyzer system comprising:
a user input device; and
a controller, the controller comprising programming and logic to:
present a user with one or more status questions related to one or more sales or marketing conditions;
receive user response to the one or more status questions;
process the received user responses; and
output a sales coaching advice package based on the received user responses.

21. The system of claim 20, wherein the advice package includes (i) a benchmark output, and/or (ii) coaching advice output.

22. The system of claim 20, wherein the controller presents a user with one or more status questions related to a dimension of a five-dimensional sales model.

23. The system of claim 22, wherein the dimensions include fit, people map, urgency, winning criteria, and banner questions.

24. The system of claim 23, wherein status questions are presented for each sales dimension until the user enters a “NO” answer.
